(19) United States
(12) Patent Application Publication
(10) Pub. No.: US 2026/0180922 A1
(43) Pub. Date: Jun. 25, 2026

(54) RETIMER TRAINING AND STATUS STATE MACHINE SYNCHRONIZATION ACROSS MULTIPLE INTEGRATED CIRCUIT DIES

(71) Applicant: Kandou Labs SA, Saint-Sulpice (CH)

(72) Inventors: Alexander Koch, Saint-Sulpice (CH); Thomas Jost, Saint-Sulpice (CH)

(73) Assignee: Kandou Labs SA, Saint-Sulpice (CH)

(21) Appl. No.: 19/128,700

(22) PCT Filed: Nov. 10, 2023
(86) PCT No.: PCT/US2023/079399

§ 371 Date: May 9, 2025

Related U.S. Application Data
(60) Provisional application No. 63/383,192, filed on Nov. 10, 2022.

(51) Int. Cl. H04L 49/101

(52) U.S. Cl. CPC H04L 49/101

(57) ABSTRACT

Methods and systems are described herein for exchanging retimer training status and state machine (RTSSM) status information between a plurality of circuit dies of a multi-chip module utilizing a ring bus configured to carry a multi-bit lane status signal using a plurality of time slots, the ring bus interconnecting the plurality of circuit dies into a ring of circuit dies, wherein each circuit die outputs stored aggregate RTSSM status information onto the ring bus to the next circuit die in the ring and stores the aggregate RTSSM status information from the preceding circuit die in the ring until each circuit die accrues the complete multi-die RTSSM status information for all of the circuit dies. Based on the complete multi-die RTSSM status information, each circuit die may synchronously execute state changes in the upstream and/or downstream RTSSMs on the circuit die.

### CROSS-REFERENCE TO RELATED APPLICATIONS

This application claims the benefit of U.S. Provisional Application No. 63/383,192, filed Nov. 10, 2022, naming Alexander Koch, entitled “Retimer Training and Status State Machine Synchronization Across Multiple Integrated Circuit Dies”, which is hereby incorporated by reference herein in its entirety for all purposes.

### REFERENCES

PCI Express Base Specification Revision 6.0.1, Version 1.0, Sep. 13, 2022, accessible at pcisig[dot]com/specifications (referred to herein as [PCIe Specification].

PCI Express Retimer Test Specification Revision 4.0, Version 1.0, Jun. 10, 2022, accessible at pcisig[dot]com/specifications.

### BACKGROUND

With increased data rate in PCIe 5.0 (32 Gbps) compared to previous generations (e.g., PCIe 4.0 MAX 16 Gbps), the channel reach becomes even shorter than before, and the need for retimers becomes more evident. Typical channels comprise system boards, backplanes, cables, riser-cards and add-in cards. Connections across these kinds of channels-often combinations of these channels and their sockets—usually have losses that exceed the specified target loss of −36 dB at 16 GHz. Retimers extend the channel reach to get across the border to what is possible without a retimer.

Retimers break a link between a host (root complex, abbreviated RC) and a device (end point) into two separate segments. Thus, a retimer re-establishes a new PCIe link going forward, which includes re-training and proper equalization implementing the physical and link layer.

While redrivers are pure analog amplifiers that boost the signal to compensate for attenuation, they also boost noise and usually contribute to jitter. Retimers instead comprise analog and digital logic. Retimers equalize the signal, retrieve their clocking, and output a signal with high amplitude and low noise and jitter. Furthermore, retimers maintain power states to keep system power low.

Retimers were first specified in PCIe 4.0. For PCIe 5.0, the usage of retimers is expected. FIG. 1A and FIG. 1B show typical applications for retimers, in accordance with some embodiments. In FIG. 1A, one retimer is employed. The retimer is located on the motherboard, and logically the retimer is between the PCIe root complex (RC) and the PCIe endpoint.

FIG. 1B shows the usage of two retimers. The first retimer is similarly located on the motherboard, while the second retimer is on a riser card which makes the connection between the motherboard and the add-in card containing the PCIe endpoint.

In complex PCIe systems, the number of PCIe endpoints can be significantly higher than the number of free PCIe ports. In such scenarios, switch devices may be used to extend the number of PCIe ports. Switches allow for connecting several endpoints to one root point, and for routing data packets to the specified destinations rather than simply mirroring data to all ports. One important characteristic of switches is the sharing of bandwidth, as all endpoints share the bandwidth of the root point.

### BRIEF DESCRIPTION

Methods and systems are described herein for exchanging retimer training status and state machine (RTSSM) status information between a plurality of circuit dies of a multi-chip module utilizing a ring bus configured to carry a multi-bit lane status signal using a plurality of time slots, the ring bus interconnecting the plurality of circuit dies into a ring of circuit dies, wherein each circuit die outputs stored aggregate RTSSM status information onto the ring bus to the next circuit die in the ring and stores the aggregate RTSSM status information from the preceding circuit die in the ring until each circuit die accrues the complete multi-die RTSSM status information for all of the circuit dies. Based on the complete multi-die RTSSM status information, each circuit die may synchronously execute state changes in the upstream and/or downstream RTSSMs on the circuit die.

This Brief Summary is provided to introduce a selection of concepts in a simplified form that are further described below in the Detailed Description. This Brief Summary is not intended to identify key or essential features of the claimed subject matter, nor is it intended to be used as an aid in determining the scope of the claimed subject matter. Other objects and/or advantages of the present invention will be apparent to one of ordinary skill in the art upon review of the Detailed Description and the included drawings.

### BRIEF DESCRIPTION OF FIGURES

FIGS. 1A and 1B illustrate two usages of retimers, in accordance with some embodiments.

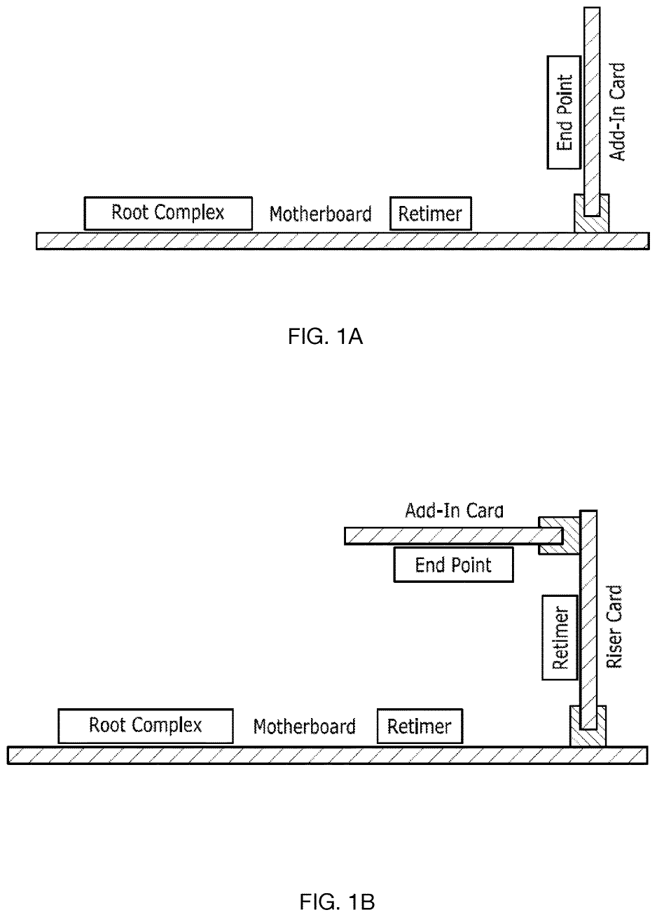

FIG. 2 is a chip configuration illustrating lane routing of data lanes of a PCIe data link through a retimer circuit, in accordance with some embodiments.

FIG. 3 includes chip configurations of a PCIe data link having lanes distributed across multiple circuit dies or “tiles”.

FIG. 4 is another chip configuration of a PCIe data link having lanes distributed across multiple circuit diesis a block diagram of a CDC buffer, in accordance with some embodiments.

FIG. 5 is block diagram of a retimer pseudo-port (PP), in accordance with some embodiments.

FIG. 6 is a flow diagram of a retimer training and status state machine (RTSSM), in accordance with some embodiments.

FIG. 7 is a block diagram of a retimer circuit die, in accordance with some embodiments.

FIG. 8 is a block diagram illustrating RTSSMs being grouped according to link configuration settings, in accordance with some embodiments.

FIG. 9 is a block diagram of a retimer composed of two circuit dies, in which vertical synchronization between RTSSMs across multiple circuit dies is illustrated, in accordance with some embodiments.

FIG. 10 is a block diagram of a retimer composed of four circuit dies, in which vertical synchronization between RTSSMs across multiple circuit dies is illustrated, in accordance with some embodiments.

FIG. 11 is a block diagram illustrating horizontal synchronization between RTSSMs across multiple circuit dies, in accordance with some embodiments.

FIG. 12 is a block diagram illustrating a ring bus interconnecting four circuit dies of a multi-chip module (MCM) in accordance with some embodiments.

FIG. 13 is a block diagram of a state synchronization pipeline (SSP), in accordance with some embodiments.

FIG. 14 is a flowchart of a method for vertical synchronization, in accordance with some embodiments.

FIG. 15 is a flowchart of a method for horizontal synchronization, in accordance with some embodiments.

### DETAILED DESCRIPTION

Despite the increasing technological ability to integrate entire systems into a single integrated circuit, multiple chip systems and subsystems retain significant advantages. For purposes of description and without limitation, example embodiments of at least some aspects of the invention herein described assume a systems environment of at least one point-to-point communications interface connecting two integrated circuit chips representing a root complex (i.e., a host) and an endpoint, (2) wherein the communications interface is supported by several data lanes, each composed of four high-speed transmission line signal wires.

Retimers typically include PHYs and retimer core logic. PHYs include a receiver portion and a transmitter portion. A PHY receiver recovers and deserializes data and recovers the clock, while a PHY transmitter serializes data and provides amplification for output transmission. The retimer core logic performs deskewing (in multi-lane links) and rate adaptation to accommodate for frequency differences between the ports on each side.

Since the retimer is located on the path between a root complex (e.g., a CPU) and an end point (e.g., a cache block) the retimer adds additional value. An integrated processing unit, e.g., an accelerator, may be integrated into the retimer performing data processing on the path from the root complex to the end point.

To allow for a highly flexible solution, the PCIe retimer has normal PHY interfaces towards the PCIe bus and a high-speed die-to-die interconnect towards a data processing unit (DPU). The high-speed die-to-die interconnect allows for very high-speed communication links between chiplets in the same package. The PCIe retimer circuit is a chiplet, a die, with a four-lane retimer and the capability to connect to a DPU chiplet via the high-speed die-to-die interconnect. One, two or four lanes can be bundled into a multi-lane link where data is spread across all the links. It is also possible to configure each lane individually to form a single-lane link. In the PCIe retimer, each lane employs two PHYs, one on each end (up- and downstream ports). Considering four lanes, eight PHYs are used in one PCIe retimer die. The PCIe retimer die also contains communication lines which allow for exchanging control information between two or more PCIe retimer dies.

The following can be built using one (or more) PCIe retimer chiplet(s). These are discussed in more detail below:
4-lane retimer
Single die, with full flexible 4×4 static lane routing
4-lane retimer with accelerator (DPU)
Two dies in one package, a retimer die and a DPU die
8-lane retimer
Two dies in one package, limited static lane routing-flexible 4×4 routing on same die but no data crossing die boundaries
8-lane retimer with full flexible lane routing
Two dies in one package, data crossing chiplets are routed through high-speed die-to-die interconnect at the cost of additional delay.
8-lane retimer with accelerator (DPU)
Three dies in package, two retimer dies and a DPU die
16-lane retimer
Four dies in one package, limited static lane routing—flexible 4×4 routing on same die but no data crossing die boundaries

### PCIe Retimer Chiplet Configurations

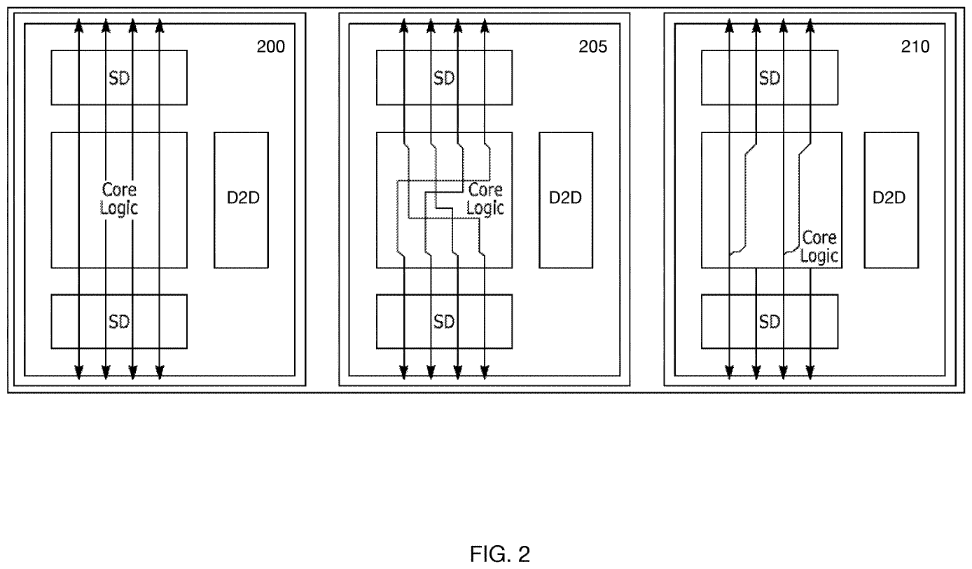

FIGS. 2-4 illustrate various configurations of a PCIe retimer circuit from a data flow perspective, in accordance with some embodiments. Each diagram depicts packages containing up to four dies. FIG. 2 illustrates three lane routing options for packages containing one die. Such an embodiment may function as a 4-lane PCIe retimer. All data from one port passes through lane routing logic to another port on the same circuit die. The Raw MUX routes each data lane individually between ports. The package 200 shows a feed-through path, package 205 shows a twisted path, and package 210 shows port mirroring. Specifically, in package 210, only one direction is shown; an additional mirroring is available in the opposite direction. In some embodiments, the serial-deserializers (SD) on the top of each configuration drawing may be connected to e.g., an upstream device, such as a root complex, while the SD on the bottom of each configuration drawing may be connected e.g., to an endpoint, or vice versa.

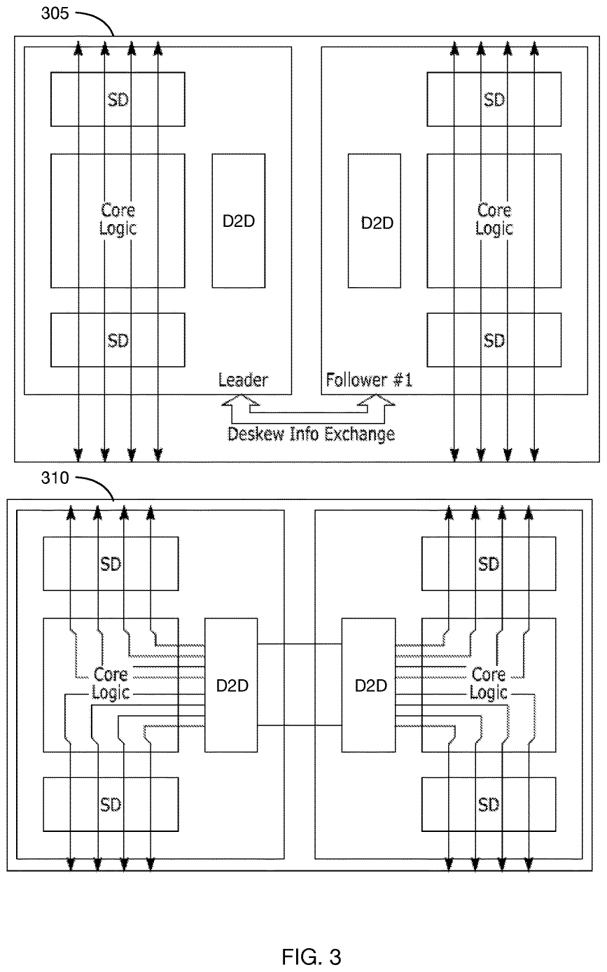

FIG. 3 shows packages for two possible two-die combinations in one package. Package 305 may correspond to an 8-lane PCIe retimer with minimum latency, having a tradeoff with respect to routing configurations as each lane is routed between upstream and downstream ports on the same die. Communication links between the two dies exchange deskew information to perform lane deskewing across all eight lanes.

Package 310 of FIG. 3 may correspond to an 8-lane PCIe retimer circuit with full routing flexibility across the circuit dies at the cost of additional latency and power dissipation from the die-to-die (D2D) interconnect. The Raw multiplexer (MUX) in each PCIe retimer circuit die routes either to the opposite port directly (as shown in 305) or to the high-speed die-to-die interconnect (as shown in 310). When routing through the high-speed die-to-die interconnect, data can be passed to the neighbor die. In such a use case, the lane-to-lane deskewing is performed on one die and no chip-to-chip deskew information is exchanged.

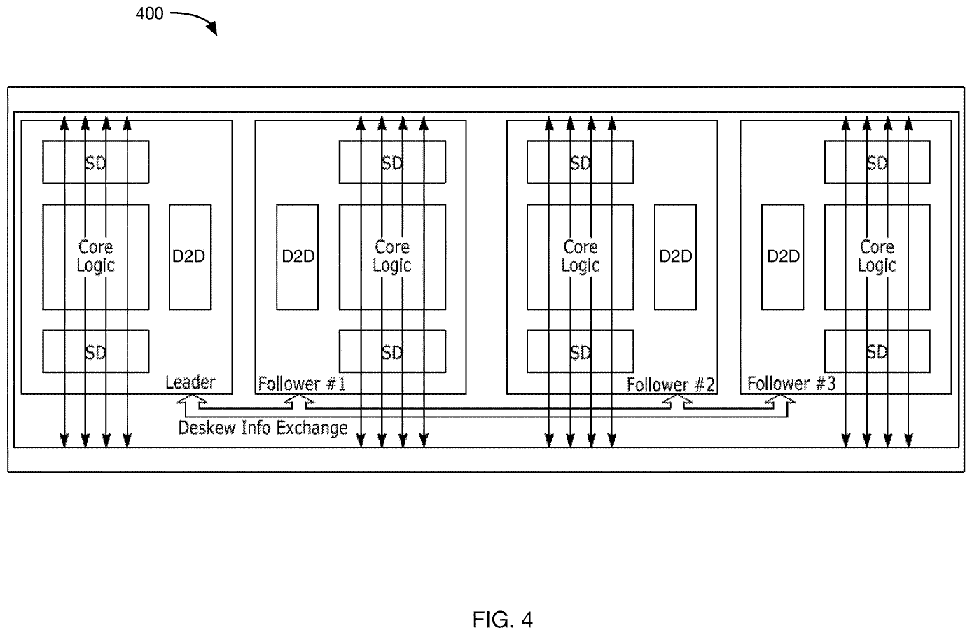

FIG. 4 shows a package 400 containing four dies. Such a package may operate as a 16-lane PCIe retimer circuit. In such an embodiment, communication links between the four dies exchange deskew information to perform lane deskewing across all 16 lanes. In such an embodiment, the D2D interconnect is not used.

### Retimer Mode

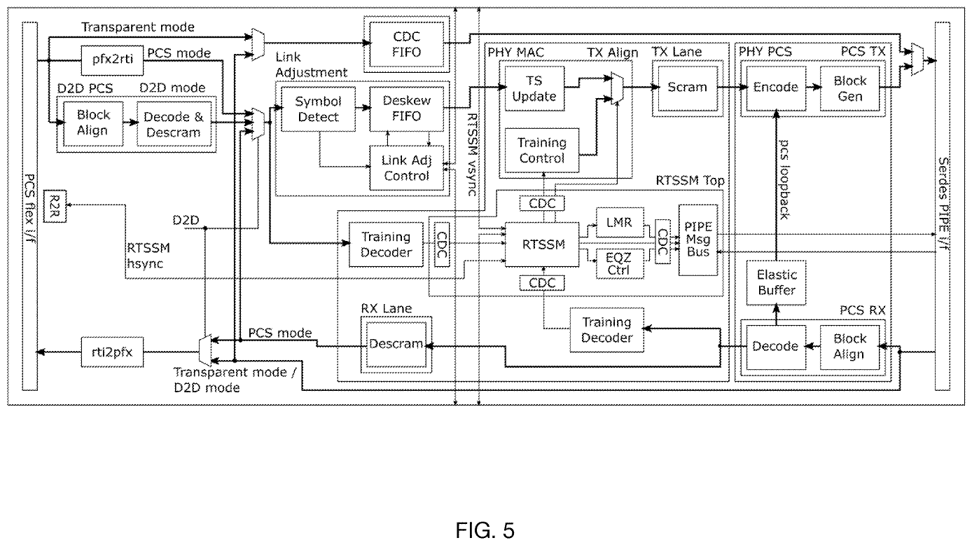

The retimer core logic for a data lane is shown in FIG. 5 and operates as follows. The core includes a PHY PCS block and a PHY MAC block. In the RX direction, data is split into an 8b10b path (for PCIe Gen1 and Gen2) and a 128b130b path (for PCIe Gen3 to Gen5). Depending on the path, code-group (COMMA) alignment or block alignment is done. The logic executing the 8b10b decoder is combined in block “PCS RX”. Both data streams are combined and forwarded to the PHY MAC block. Data are aligned to 8-bit symbol boundaries in 8b10b mode (symbols start at bit 0, 8, 16 or 24) and to blocks in 128b130b mode (a new block starts at bit 0, all following 32-bit chunks are aligned to bit 0 as well). In the TX direction of data flow, data from the PHY MAC block is processed in the “PCS TX” block. Data are split into two data paths: Gen1 and Gen2 data are 8b10b encoded, and Gen3 to Gen5 data are 128b130b encoded.

In the RX direction of the PHY MAC block, data are descrambled in the RX Lane block and forwarded to “rti2pfx” converting the “retimer internal bus” (rti) formatted data into a “PCS-Flexbus” (pfx) format used between the RPCS blocks. At the same time, the PCS data are forwarded to a training decoder. The “TX Align” block synchronizes switching between “Forward” mode and “Execution” mode. While in “Forward” mode data are taken from “TS Update” block (see below), while in “Execution” mode data are taken from a Training Control unit for Link Training.

In TX direction, some fields of the data are partially updated to inform subsequent blocks about retimer(s) presence in the data paths between the root complex and the endpoint. Such updates are performed in block “TS Update” which is part of the “TX Align” block. An additional Training Decoder block extracts data from the TX data stream so the retimer training status state machine (RTSSM) may observe control data from both directions. The RTSSM is the central controlling unit. It switches between “Forward” and “Execution” mode, controls link training, and observes the complete retimer core logic.

The Symbol Detection block extracts COM symbols as part of TS1/TS2 (8b10b) or SKP ordered sets or EIEOS ordered sets (128b130b) for Deskewing. The Deskew FIFO (Elastic Buffer) is used to perform lane-to-lane alignment (deskewing) as well as rate adaptation to compensate for small frequency offsets between receive and transmit clock. The Link Adjustment Control block controls deskewing and rate adaptation. It handles varying number of lanes to support bifurcation. For the full-flexible 8-lane mode and the D2D Transparent mode where data are fed through the D2D interface, the FIFO write side writes two words within one clock cycle at a lower frequency. After successful alignment this block starts by generating a EIEOS block(s) aligned with ordered set boundaries before it forwards data. The link adjustment block may stop data transmission and send EIOS blocks to terminate the data stream. Transmission of EIOS blocks is aligned with ordered set boundaries. The Link Adjustment block is also responsible for fetching data from the Elastic Buffer. Since the PCS-TX logic adds Sync-Header bits into the 128b130b data stream, it inserts idle cycles to compensate for bandwidth increase. Specifically, 128b130b inserts 2 bits every 128 bits, and thus an idle/inactive cycle may be inserted every 64 clock cycles). The Link Adjustment block also provides electrical idle information per symbol as sideband information. The electrical idle information is used by the attached PHY to generate an electrical idle on the high-speed serial TX lanes. The generation of the electrical idle sideband information is synchronized with the output data stream.

The clock domain crossing (CDC) FIFO is a drift buffer allowing for transparent data forwarding from one PHY (PIPE interface) to the opposite PHY. The CDC FIFO performs clock domain crossing and may have a depth of four entries, however such a depth should not be considered limiting. The FIFO depth may be designed to be small to reduce latency but large enough to maintain sufficient distance between the read and write pointers so that the pointers do not collide.

In FIG. 5, the retimer core logic is shown as including PCS encoders and decoders for the 8b10b encoding/decoding functions of PCIe generations 1 and 2 and the 128b/130b encoding/decoding functions of PCIe generations 3-5. It should be noted that such encoders/decoders may be omitted in modes of operation that employ PCIe generation 6, which utilizes a flow control unit (FLIT) scheme, and thus no 8b10b or 128b130b is implemented. In such embodiments, the functionalities for encoding/decoding may be omitted, while additional functionalities specific to PCIe 6, such as FEC decoding (either partial or full) are included as logic in the data path. Some functionalities of retimer core logic are shared, such as lane-to-lane deskewing and rate adaptation in the FIFO.

### Retimer Training Status and State Machines (RTSSM)

FIG. 5 also includes a retimer training and status state machine (RTSSM) for a given pseudo-port type for a given lane. The RTSSM is the central training and status state machine in a retimer. Root Complexes (RC) and End Points (EP) each use a Link Training and Status State Machine (LTSSM) responsible for negotiating the link speed and link width depending on advertised abilities between the two link partners. A RTSSM in a Retimer extracts this information and sets up the data rate and link width of the Retimer accordingly. The RTSSM may also limit the speed and link width via configuration registers accessible via the CPU subsystem. For this purpose, the data rate fields in TS1 and TS2 are updated accordingly. The RTSSM stores the negotiated link parameters in a status register accessible via CPU subsystem. In PCIe retimers described herein, each data lane of a link includes two RTSSMs; one in the upstream direction and one in the downstream direction. Methods and systems are described herein for synchronizing the RTSSMs of a data link when (i) pseudo-ports of the same type are distributed across circuit boundaries and RTSSM status information for the same-pseudo-port-type (RTSSM_vsync) is distributed between circuit dies, and (ii) the data lanes cross circuit die boundaries and lane-specific status information associated with the RTSSM of the same lane having the opposite pseudo-port type (RTSSM_hsync) is distributed between circuit dies. In the following, two modes of operation of a multi-die PCIe data link are discussed with synchronization techniques for each mode of operation.

As shown in FIG. 5, two synchronization channels are connected to the RTSSM: a hsync channel ‘RTSSM_hsync’ and a vsync channel ‘RTSSM_vsync’ for performing horizontal and vertical synchronization, respectively.

Retimers described herein offer a highly flexible solution for lane routing configurations between upstream and downstream pseudo-ports through the use of two RTSSMs per lane in any given PCIe data link; one RTSSM in the upstream PP and one RTSSM in the downstream PP. Thus, for any given PCIe data link having N lanes, 2*N RTSSMs are active. Embodiments are described herein for synchronizing all RTSSMs participating in a PCIe data link by exchanging inter-pseudo-port (inter-PP) RTSSM status information between the two RTSSMs participating in the same lane but of opposite pseudo-port type (also referred to herein as horizontal synchronization) using a horizontal synchronization channel. Furthermore, intra-pseudo-port (intra-PP) RTSSM status information is exchanged between RTSSMs of the same pseudo-port type (also referred to herein as vertical synchronization) using a vertical synchronization channel.

Inter-PP RTSSM status information may be exchanged e.g., in a receiver detection process. For example, when a root complex initiates receiver detection, the root complex interacts with upstream RTSSMs. The endpoint is connected to the downstream RTSSMs. Each downstream RTSSM is notified, via the respective horizontal sync bus, to initiate receiver (i.e., endpoint) detection. When the downstream RTSSMs detect the endpoint, they may signal back to the upstream RTSSMs via the horizontal sync bus that the endpoint has been detected and the next processes in the link training may begin.

Thus, the RTSSMs in the upstream and downstream RPCS blocks forming a single data lane, while not necessarily always in the same state, exchange status information with each other. Table I below includes exemplary horizontal sync status information exchanged between RTSSMs in the same lane:

TABLE I

| Signal Name | Width (bits) | Description |
|---|---|---|
| rx_rcv_det | 1 | Receiver detected |
| rx_rcv_idle | 1 | Receiver sees electrical idle on |
| | | input |
| phy_status | 1 | PHY is ready after reset or rate |
| | | change |
| rx_valid | 1 | Receiver is receiving valid data |
| rtssm_state_event | 2 | RTSSM has changed to next |
| | | state A/B. Meaning depends on |
| | | current RTSSM state. Signal |
| | | will change polarity on state |
| | | transition event. |
| res | 2 | Reserved |

As mentioned above, in addition to horizontal synchronization, RTSSMs of the same pseudo-port type exchange intra-pseudo-port (intra-PP) RTSSM status information for notifying other RTSSMs of the same pseudo-port participating in the multi-lane PCIe data link about current state machine status that may be useful for synchronously progressing all of the RTSSMs of the same pseudo-port between states. Intra-PP RTSSM status information may include AND conditions, e.g., the RTSSMs of a pseudo-port type progress to a new state if a condition is found in every lane, and OR conditions, e.g., the RTSSMs progress to a new state if the condition is found in any lane.

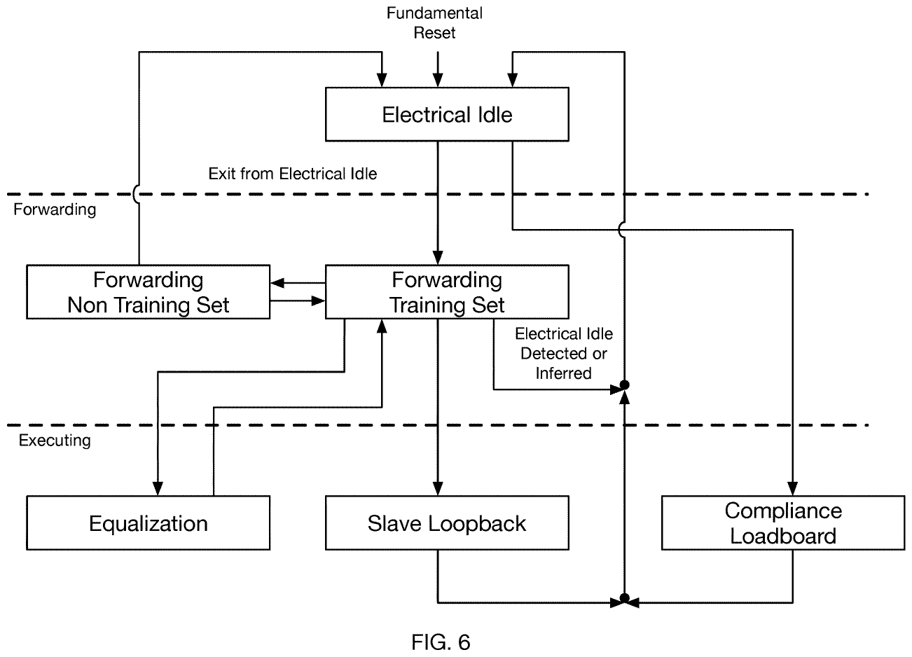

A block diagram of a RTSSM fulfilling the standardized requirements of the PCI base specification and the specific requirements listed in this document is shown in FIG. 6. As shown in FIG. 6, the RTSSM state diagram includes an Electrical Idle state. During Fundamental Reset, the state machine starts at the Electrical Idle state. All pseudo-ports are high impedance during the Fundamental Reset. Shortly after the Reset is released, the transmitters in the pseudo-ports perform a receiver detection and the results are propagated to corresponding lanes of other pseudo-ports (Receiver Impedance Propagation). The LTSSMs in the Root Complex and in the Endpoint, which are connected at the ends of the data link, are in a Detect state and perform a receiver detection. As soon as the LTSSMs see a low impedance at the receiver, LTSSMs go into a Polling state and start to send TSIs (Training Sequence 1 Ordered Set). A PCIe link starts up with 2.5 GT/s. In 2.5 GT/s the exit from Electrical Idle is detected with analog circuitry in the PHY. Thus, TSIs lead to an exit from Electrical Idle.

If the TSIs come from one pseudo-port only, the Retimer is connected to a Load Board and changes to Compliance Load Board state. In a PCIe application the Retimer is connected in a PCIe Link and therefore receives TSIs on both pseudo-ports since both LTSSMs at the end of the Link are in the Polling state. Therefore, the RTSSM change state to Forwarding Training Set. The detailed RTSSM behavior is more complex and additional states are added to capture all requirements.

In the Forwarding Training Set state, data is sent between pseudo-ports. Data contains training ordered sets which include TSIs and TS2s. If the Retimer receives several Logical Idle patterns, the state is changed to Non-Forward Training Sets. The Logical Idle pattern is sent by the LTSSMs in the Root Complex and the Endpoint when they change to L0 state from Configuration state or Recovery State.

The following are three conditions for entering one of the three states in execution mode from the Forwarding Training Set state:
If the Equalization Control field in TS1 is equal to ‘10b’ several times and then the state switches to Equalization state.
If a pseudo-port receives several TSIs or TS2s with the Loopback bit set, the RTSSM changes the state to Slave Loopback Mode.
If Electrical Idle Ordered Set is detected or Electrical Idle is inferred, the RTSSM changes to state Electrical Idle.

Forwarding Non Training Set: This is the state for forwarding data. Data is transferred in L0 state of LTSSMs of Root Complex and Endpoint. RTSSM is in this state, when LTSSMS are in L0 state. If several TSIs and TS2 are received, RTSSM state changes to Forward Training Set.

Equalization: The LTSSMs in Root Complex and Endpoint are in the Recovery state. In the equalization state, for each Link Segment the best settings for Equalization of the Transmitters are determined. Since it happens on each Link Segment of the pseudo-ports, the Retimer executes the Equalization Training on each Link Segment with the connected pseudo-port separately and goes to Execution Mode. When Equalization is finished, the RTSSM returns to Forwarding Training Set state.

In the Follower Loopback state, received data is sent via Transmitters which also allows testing of Receivers. After testing is finished, the next state is Electrical Idle.

Compliance Load Board: The Retimer is connected to a Load Board and it sends compliance pattern for testing the Transmitters. After testing is finished, the next state is Electrical Idle.

### RTSSM Synchronization

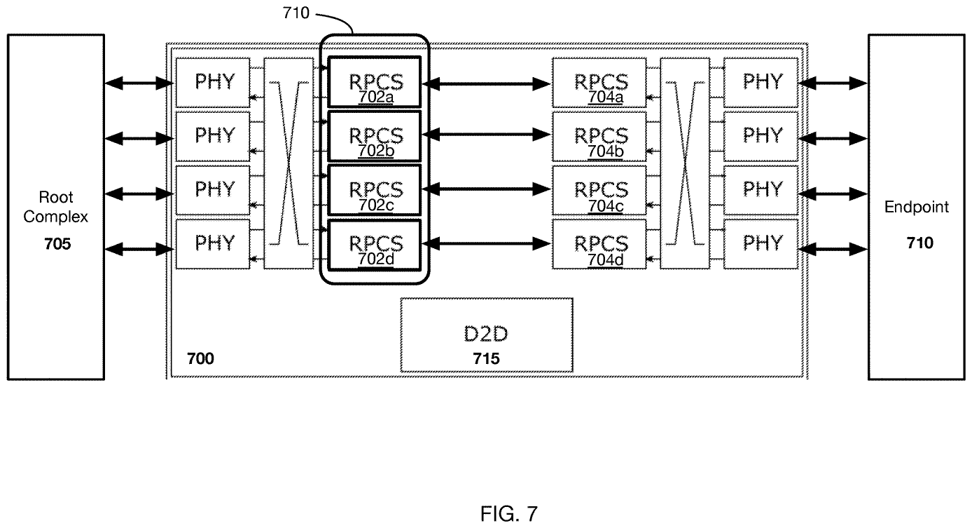

FIG. 7 is a block diagram of a retimer circuit die 700, in accordance with some embodiments. As shown, FIG. 7 includes 8 ports, each having a PHY and respective core logic 702a-d and 704a-d. The RTSSM for each port may be contained within the core logic. The configuration shown in FIG. 7 is a four-lane PCIe link between a root complex 705 and endpoint 710. Retimer circuit die 700 further includes a die-to-die (D2D) interface 715 to communicate with other circuit dies in a multi-chip package. Such an interface may be e.g., a Universal Chiplet Interconnect express (UCIe) interface, or another chip-to-chip interconnect.

As shown in FIG. 7, the eight ports are subdivided into four ports of an upstream pseudo-port (containing core logic 702a-d) and four ports of a downstream pseudo-port (containing core logic 704a-d).

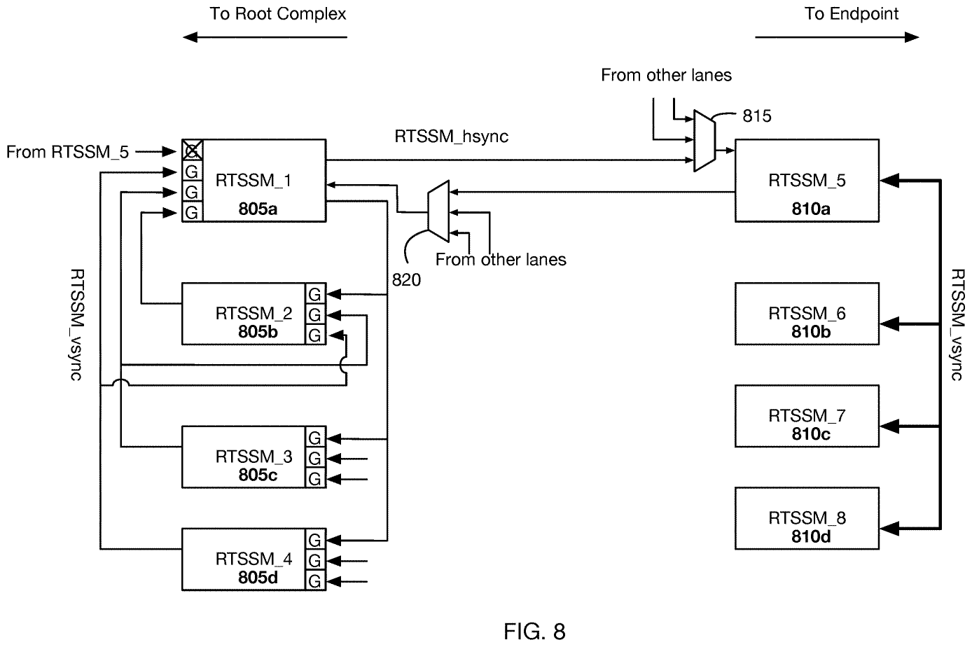

FIG. 8 is a block diagram illustrating horizontal and vertical synchronization between RTSSMs in a retimer circuit die operating in a PCIe data path. While a four-lane link is shown, such a constraint should not be considered limiting. FIG. 8 includes four upstream RTSSMs 805a-d and four downstream RTSSMs 810a-d. A horizontal sync channel is shown between RTSSM_1 805a and RTSSM_5 810a. As shown, the horizontal sync channel includes hsync input selection logic 815 and 820 for RTSSM_5 and RTSSM_1, respectively. Each hsync input selection logic 815 may have inputs connected to every other RTSSM; one of which is selected depending on a desired lane configuration. The hsync input selection logic 815 and 820 shown in FIG. 8 is in the form of a multiplexer, however other circuit may be used as well. In some embodiments, the multiplexer receives an input selection signal from a configuration register in the retimer circuit die. The configuration register may be configured via an active CPU core on the retimer circuit die. The active CPU core may configure the entire configuration register space of the retimer circuit die based on desired PCIe link configuration(s).

Similarly, vertical synchronization between RTSSMs of the same pseudo-port ensures that no RTSSM progresses to a new state until all RTSSMs of the pseudo-port are ready to progress. In FIG. 8, the vertical sync channel is illustrated as a parallel set of wires between the upstream RTSSMs 805a-d. Each upstream RTSSM provides vertical sync RTSSM status information to every other upstream RTSSM. As shown in FIG. 8, each RTSSM further includes gated inputs configured to accept or reject intra-PP RTSSM status information from the rest of the RTSSMs. The vertical sync inputs for each RTSSM are gated to ensure that each upstream RTSSM receives only the vertical sync RTSSM status information from the other upstream RTSSMs participating in the same PCIe link. In some embodiments, the CPU core similarly configures the vsync channel by selectively enabling or disabling each gated input for every RTSSM based on a desired lane routing configuration. As shown in FIG. 8, RTSSM_1 the gated inputs are enabled for intra-PP RTSSM status information received from RTSSM_2:4, while the gated input for the intra-PP RTSSM status information received from RTSSM_5 is disabled. In some embodiments, in a fully flexible solution, each RTSSM may have vertical sync inputs from every other RTSSM in the circuit die, as well as from RTSSMs on other circuit dies, as described in more detail below.

As described above, the information exchanged via the horizontal and vertical sync channels of the RTSSM status information exchange channel may take the form of OR and AND logic conditions. OR logic conditions mean the RTSSMs take action if a condition appears in ANY lane, while AND logic conditions means the RTSSMs take action if a condition appears in EVERY lane. Further, the OR and AND logic conditions exchanged by the RTSSMs may take on different meanings depending on the current state of the RTSSMs.

FIG. 8 is a simplified diagram illustrating only a subset of total connections between RTSSMs, and it is thus understood that similar connections, while not explicitly shown, exist between the RTSSMs.

In some embodiments, an apparatus includes a plurality of pseudo-ports (PPs) comprising an upstream PP and a downstream PP, each PP including one or more physical layer transceivers (PHYs). The apparatus further includes a plurality of retimer training and status state machines (RTSSMs), each RTSSM configured to manage a corresponding PHY. The apparatus further includes lane routing logic configured to route data between each PHY in the upstream PP and corresponding PHYs in the downstream PP. The apparatus further includes a horizontal synchronization (hsync) channel configured to exchange inter-PP RTSSM status information between each RTSSM in the upstream PP and a corresponding RTSSM in the downstream PP. The apparatus further includes a vertical synchronization (vsync) channel configured to exchange respective intra-PP RTSSM status information amongst RTSSMs in the upstream PP and amongst RTSSMs in the downstream PP.

In some embodiments, the apparatus further includes a central processing unit (CPU) core for configuring the hsync channel and the vsync channel. In some embodiments, each RTSSM is configured to output inter-PP RTSSM status information and intra-PP RTSSM status information to every other RTSSM. In some embodiments, each RTSSM comprises a hsync input selection circuit and wherein the CPU core configures the hsync channel by configuring the input selection circuit of each RTSSM to accept the inter-PP RTSSM status information from a corresponding one other RTSSM of an opposite pseudo-port type. In some embodiments, the hsync input selection circuit is a multiplexing circuit. In some embodiments, the multiplexing is configured to receive a selection input from a configuration register, the configuration register configured via the CPU core.

In some embodiments, each RTSSM comprises gated inputs configured to selectively receive intra-PP RTSSM status information from the RTSSMs of a same PP type while rejecting intra-PP RTSSM status information from the RTSSMs of a different PP type, and wherein the CPU core configures the vsync channel by selectively enabling or disabling each gated input according to a desired lane configuration.

In some embodiments, the plurality of pseudo-ports are on a first retimer circuit die and a second retimer circuit die interconnected to the first retimer circuit die via a die-to-die (D2D) data interface and a D2D RTSSM sync channel. In some embodiments, the PHYs of the upstream PP are on the first retimer circuit die and wherein the PHYs of the downstream PP are on the second retimer circuit die. In some embodiments, the D2D RTSSM sync channel interfaces to the hsync channel to exchange the inter-PP RTSSM status information between the first and the second retimer circuit dies.

In some embodiments, a first PHY of the upstream PP and the corresponding PHY of the downstream PP are on the first retimer circuit die, and wherein a second PHY of the upstream PP and the corresponding PHY of the downstream PP are on the second circuit die. In some embodiments, the D2D RTSSM sync channel interfaces to the vsync channel to exchange the intra-PP RTSSM status information (i) amongst the RTSSMs associated with the first and second PHYs of the upstream PP and (ii) amongst the RTSSMs associated with the corresponding PHYS of the downstream PP.

In some embodiments, a method includes routing data between physical layer transceivers (PHYs) of a plurality of pseudo-ports (PPs) comprising an upstream PP and a downstream PP, managing each PHY using a respective plurality of retimer training and status state machines (RTSSMs), exchanging, using a horizontal synchronization (hsync) channel, inter-PP RTSSM status information between each RTSSM in the upstream PP and a corresponding RTSSM in the downstream PP, and exchanging, using a vertical synchronization (vsync) channel, respective intra-PP RTSSM status information amongst RTSSMs in the upstream PP and amongst RTSSMs in the downstream PP.

In some embodiments, the method further includes grouping, using a central processing unit (CPU) core, the PHYs of the plurality of PPs into the upstream PP and the downstream PP by configuring the hsync channel and the vsync channel. In some embodiments, the method further includes providing the inter-PP RTSSM status information and the intra-PP RTSSM status information for a given RTSSM to every other RTSSM. In some embodiments, the method further includes selecting, at each RTSSM of the PHYs of a first PP of the plurality of PPs, the inter-PP RTSSM status information from a corresponding one other RTSSM of the PHY of a second PP of the plurality of PPs. In some embodiments, the selection is performed using an hsync input selection circuit. In some embodiments, the method further includes configuring the hsync input selection circuit using the CPU core. In some embodiments, the hsync input selection circuit is a multiplexing circuit, and the method includes configured the multiplexing circuit to receive a selection input from a configuration register, the configuration register configured via the CPU core.

In some embodiments, the method further includes configuring gated inputs of each RTSSM of the PHYs of a first PP of the plurality of PPs to selectively receive intra-PP RTSSM status information from the remaining RTSSMs of the PHYs of the first PP while rejecting intra-PP RTSSM status information from the RTSSMs of the PHYs of a second PP of the plurality of PPs, and wherein the CPU core configures the vsync channel by selectively enabling or disabling each gated input according to a desired lane configuration.

In some embodiments, the plurality of pseudo-ports are on a first retimer circuit die and a second retimer circuit die interconnected to the first retimer circuit die via a die-to-die (D2D) data interface and a D2D RTSSM sync channel. In some embodiments, the PHYs of the upstream PP are on the first retimer circuit die and wherein the PHYs of the downstream PP are on the second retimer circuit die. In some embodiments, the method further includes exchanging the inter-PP RTSSM status information between the first and the second retimer circuit dies using the D2D RTSSM sync channel.

In some embodiments, wherein a first PHY of the upstream PP and the corresponding PHY of the downstream PP are on the first retimer circuit die, and wherein a second PHY of the upstream PP and the corresponding PHY of the downstream PP are on the second circuit die. In such embodiments, the method further includes exchanging the intra-PP RTSSM status information (i) amongst the RTSSMs associated with the first and second PHYs of the upstream PP and (ii) amongst the RTSSMs associated with the corresponding PHYs of the downstream PP using the D2D RTSSM sync channel interfaces.

### Multi-Tile RTSSM Synchronization

Embodiments described herein include multi-chip module (MCM) retimers that offer full flexible lane routing capabilities in retimer mode. As such, the RTSSM status information described above may also need to be exchanged across circuit die boundaries.

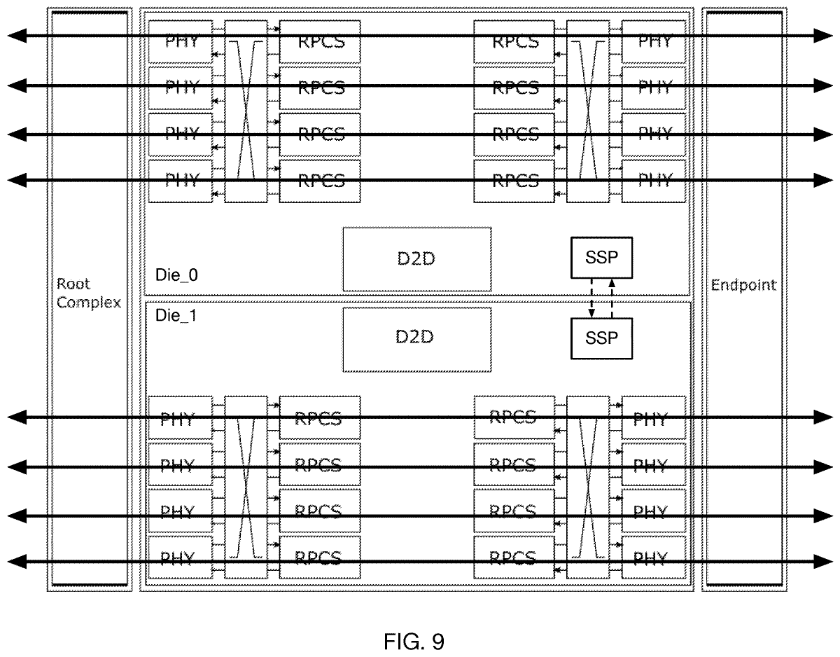

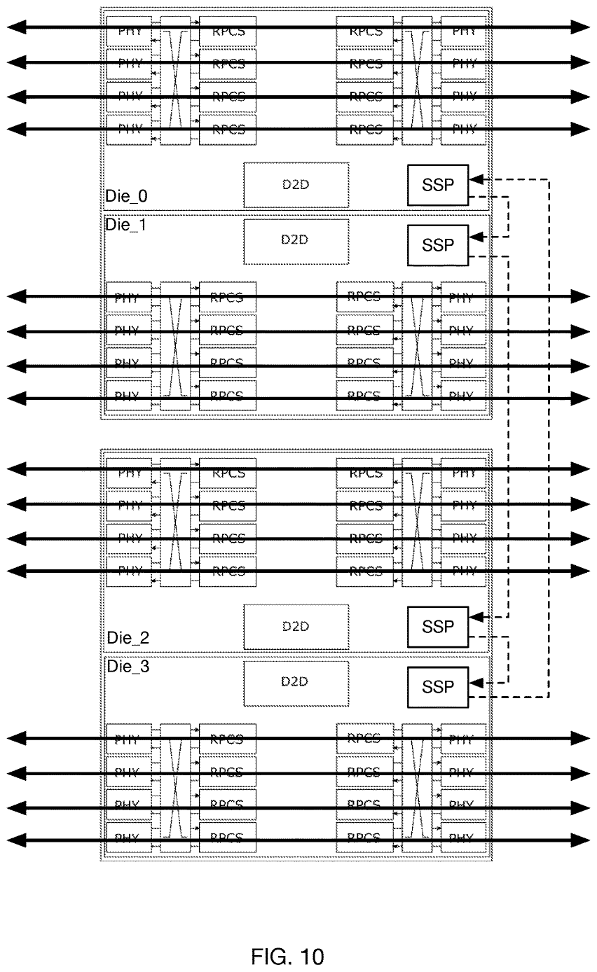

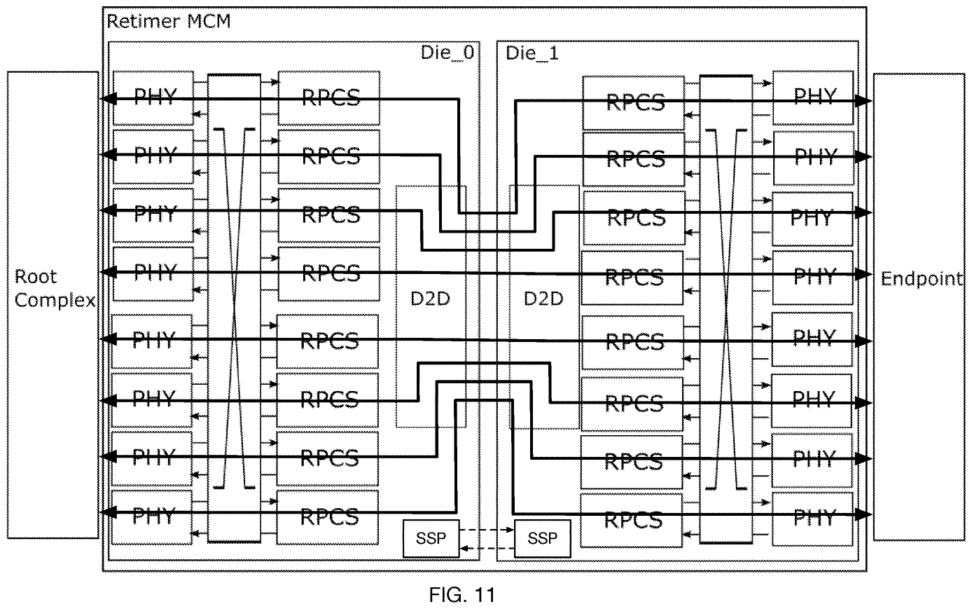

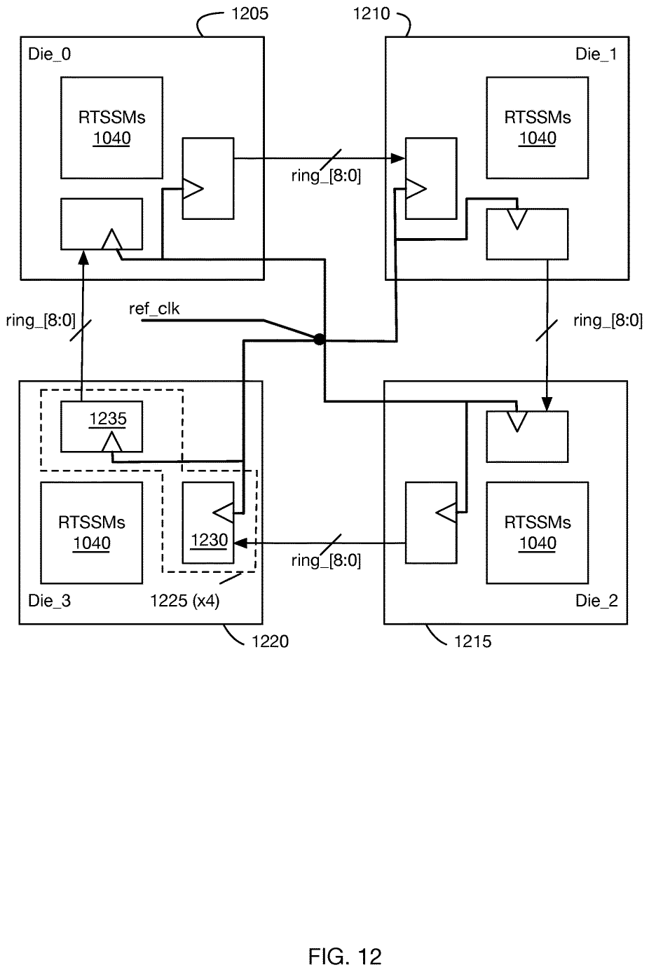

FIGS. 9-11 illustrate various multi-chip configurations for such a retimer. FIG. 9 is a block diagram of a PCIe retimer having 8 lanes distributed across two circuit dies Die_0 and Die_1. FIG. 10 is a block diagram of a PCIe retimer having a 16 lanes distributed across four tiles Die_[3:0]. In FIGS. 9 and 10, The upstream and downstream ports of a given lane are located on the same tile, and thus horizontal sync RTSSM status information may be exchanged directly in a manner as described above with respect to FIG. 8, while vertical sync RTSSM status information is exchanged using tile-to-tile connections between the circuit dies. In FIGS. 9 and 10, the total number of lanes may be bifurcated. E.g., FIG. 9 may include 2×4 PCIe data links, each link communicated via a respective circuit die. FIG. 10 supports 2×8 PCIe data links, each x8 data link communicated using two circuit dies. FIG. 11 is a block diagram of a PCIe retimer having 8 lanes distributed across two tiles that allows for full lane routing flexibility between PHYs in the upstream and downstream PPs. In FIG. 11, all the RTSSMs of the upstream PP are located on Die_0 while all the RTSSMs of the downstream PP are located on Die_1. Thus, the vertical sync RTSSM status information for RTSSMs in each PP may be exchanged directly, while the horizontal sync RTSSM status information is exchanged using the tile-to-tile connection. Neither the number of tiles nor the number of lanes in the data link should be considered limiting. As shown in FIGS. 9-11, each lane of a PCIe data link includes both upstream and downstream core logic containing respective RTSSMs. FIG. 12 is a block diagram of an apparatus, in accordance with some embodiments. As shown, the apparatus includes a plurality of circuit dies 1205/1210/1215/1220 for retiming serial data links from a root complex to an endpoint. A plurality of data lanes is distributed across the plurality of circuit dies that form a PCIe data link, each data lane comprising a respective upstream and downstream retimer training status and state machine (RTSSM). In some embodiments, as shown in FIGS. 7 and 8, the RTSSMs of the upstream and downstream pseudo-ports for a given data lane are contained within the same circuit die while the RTSSMs of the same pseudo-port type are distributed across the plurality of circuit dies. While the embodiment shown in FIG. 12 illustrates four circuit dies, such a number should not be considered limiting. For example, a similar embodiment may include two circuit dies in the full-flexible lane routing 8-lane retimer of FIG. 11. In FIG. 11, all upstream pseudo-ports for the data link are located on a first circuit die while all downstream pseudo-ports for the data link are located on a second die, and ‘RTSSM_hsync’ synchronization information is exchanged across the tiles.

The apparatus further includes a die-to-die RTSSM sync channel, referred to herein as a “ring bus”. It should be noted that the term “ring bus” in the context of this description may mean a group of parallel wires, or other signal conductors of the like. The signal conductors interconnect the plurality of retimer circuit dies in a ring, as shown in FIG. 12. As shown, ring bus ring_[8:0] is connected between each retimer circuit die and is configured to carry a multi-bit lane status signal, the multi-bit lane status signal comprising aggregate RTSSM status information for each circuit die that collectively forms complete multi-die RTSSM status information. The ring bus ring_[8:0] is a 9-bit wide bus, however such a width should not be considered limiting. In the operational modes shown in FIGS. 7 and 8, the aggregate RTSSM status information conveyed utilizing the multi-bit lane status signal corresponds to vertical sync RTSSM status information for RTSSMs of the same pseudo-port type (intra-PP RTSSM status information). In the operational mode shown in FIG. 11, the aggregate RTSSM status information conveyed utilizing the multi-bit lane status signal corresponds to horizontal sync RTSSM status information for RTSSMs of the same data lanes (inter-PP RTSSM status information), in which the upstream and downstream pseudo-ports are located on different circuit dies. The complete multi-die RTSSM status information corresponds to the aggregate RTSSM status information for all the circuit dies. In some embodiments, the operational modes of e.g., FIG. 9 and FIG. 11 are mutually exclusive, and the same ring bus may be selectively configured to transport either inter-PP RTSSM status information or intra-PP RTSSM status information, depending on the lane routing configuration. In some embodiments, the ring bus may be extended to convey both inter-PP and intra-PP RTSSM status information, by way of a larger parallel interface and/or additional time slots.

### Multi-Tile Vertical Synchronization

As described above, RTSSMs change from old state to new state often based on AND conditions (the condition is true on all lanes) and OR conditions (the condition is true on any lane).

As shown in FIG. 12, each circuit die includes a state synchronization pipeline (SSP), e.g., SSP 1225. Each SSP 1225 may include e.g., an input register 1230 and output register 1235. The SSP 1225 in a given circuit die is configured to receive the multi-bit lane status signal and to accrue the complete RTSSM status information by incrementally storing the aggregate RTSSM status information from the remaining circuit dies via input register 1230, and to output RTSSM status information pertaining to the given circuit die onto the parallel ring bus using output register 1235.

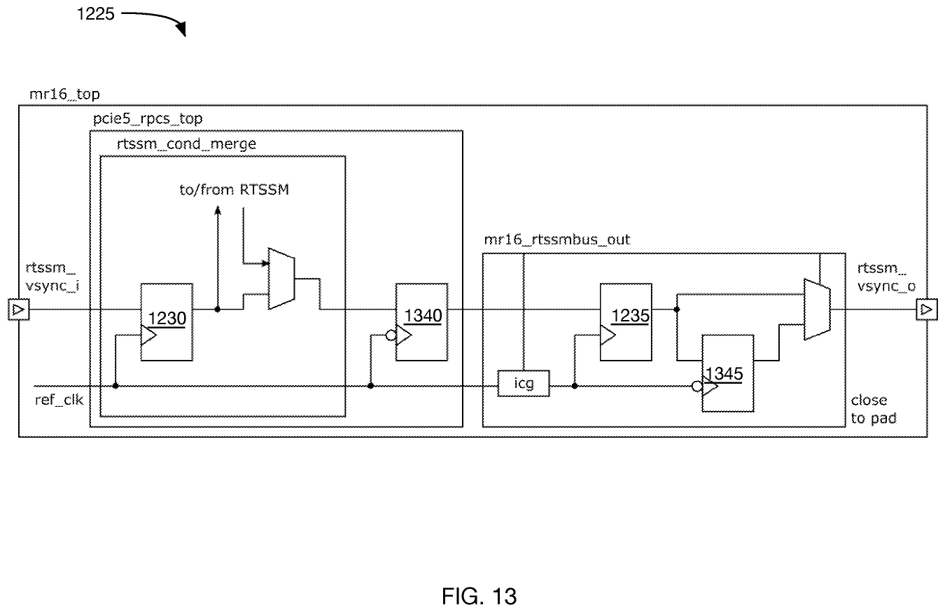

FIG. 13 is a block diagram of a SSP 1225, in accordance with some embodiments. As shown, aggregate vertical RTSSM status information ‘RTSSM_vsync_i’ is clocked in using input register 1230 according to the reference clock, stored, and subsequently clocked out ‘RTSSM_vsync_o’ by the reference clock using output register 1235. The SSP 1225 further includes additional registers 1340 and 1345 clocked on the opposite edge of the reference clock for e.g., timing variation constraints. While FIG. 13 illustrates the SSP logic exchanging vertical sync RTSSM status information, it should be noted that the same SSP may be alternatively utilized to exchange horizontal sync RTSSM status information depending on the retimer configuration.

The RTSSMs 1240 in each circuit die are configured to analyze the aggregate RTSSM status information of the plurality of circuit dies upon synchronous accrual of the complete multi-die RTSSM status information, and to synchronously execute a state change in the circuit die. For simplicity, one RTSSM 1240 is shown in each circuit die, however it should be noted that each lane involved in the data link includes both an upstream and a downstream RTSSM. Furthermore, the upstream and downstream RTSSMs 1240 analyze the complete multi-die RTSSM status information for the same pseudo-port type to determine if a state change condition is met.

In FIG. 12, the ring bus is shown as a multi-wire parallel bus interconnecting each circuit die, having N wires. In some embodiments, N is an integer greater than 1. In some alternative embodiments, the ring bus may be a single wire, however the following example includes a multi-wire parallel ring bus. The ring bus is configured to circulate the multi-bit lane status signal around the plurality of circuit dies over the course of a ring cycle, which may include multiple time slots. In at least one embodiment without implying limitation, the ring cycle includes nine time slots used to propagate the aggregate RTSSM status information around the ring bus such that each circuit die captures the aggregate RTSSM status information from the rest of the circuit dies to synchronously accrue the complete multi-die RTSSM status information.

In some embodiments, the SSP 1225 in each circuit die may include a respective slot counter. The slot counter in each SSP 1225 for each tile may be synchronized according to a synchronization bit that propagates around the circuit dies via a predetermined position in the multi-bit lane status signal. The remaining positions in the multi-bit lane status signal are used for the AND and OR conditions of the aggregate RTSSM status information that is conveyed around the circuit dies using the ring bus. In at least one embodiment, synchronizing the slot counters in each tile includes setting the slot counter of tile M to 2*M upon reception of the synchronization bit, where M={0, 1, 2, 3}. Specifically, the synchronization bit starts in tile 0 (1205) and initializes the count value of slot counter for tile 0 to ‘0’. The synchronization bit is then transferred via the ring bus to tile 1 (1210) over the course of two reference clock cycles, and the count value of the slot counter in tile 1 is initialized to ‘2’, while the count value in the slot counter of tile 0 has also incremented to a value of ‘2’. The synchronization bit is transferred from tile 1 to tile 2 (1215) via the ring bus after another two reference clock cycles and the count value of the slot counter in tile 2 is initialized to ‘4’, while the slot counters for tiles 0 and 1 have also incremented to 4 during this time. Lastly the count value of tile 3 (1220) is initialized to a count value of ‘6’ as and the count values for the remaining tiles reaches ‘6’, and thus the slot counters are synchronized. Once the count values of the slot counters in each tile are synchronized, the aggregate status information for each tile is transferred around the ring bus. E.g., the aggregate status information for tile 0 is transmitted to tile 1, while simultaneously the aggregate status information for tile 1 is transmitted to tile 2, etc. At the same time, tile 0 captures the aggregate RTSSM status information from tile 3. Each tile captures the aggregate RTSSM status information from the preceding tile while simultaneously outputting the currently held aggregate RTSSM status information. Over the next couple of time slots, tile 0 transmits the aggregate RTSSM status information for tile 3 to tile 1, while tile 1 transmits the aggregate RTSSM status information for tile 0 to tile 2, etc. While the transfers on the ring bus occur, the slot counters in each SSP may continue incrementing. Once the slot counter in each tile reaches a predetermined value, e.g., a value indicating that a ring cycle is complete and thus accrual of the multi-die RTSSM status information is complete, the upstream and downstream RTSSMs in each circuit die may analyze the complete multi-die RTSSM status information of the same pseudo-port type to synchronously execute a state change if prompted.

In some embodiments, the slot counter in each tile may be utilized to distinguish between RTSSM status information for two separate links. For example, in the embodiment of FIG. 10, two x8 lane links may be present: one link distributed across the top-two circuit dies Die_0 and Die_1 and another link distributed across the bottom-two circuit dies Die_3 and Die 4. In such an embodiment, upstream and downstream RTSSM status information for the first and second links is conveyed around the circuit dies using the ring bus, while slot counters within each circuit die are used to determine when to accept the RTSSM status information on the bus. A specific example for a nine-slot ring bus is given below.
Each circuit die may output their own AND and OR conditions for both the upstream and downstream RTSSMs during slots 0 and 1.
Each circuit die outputs AND and OR conditions for the preceding circuit die during slots 2 and 3 (e.g., circuit die 805 outputs the AND and OR conditions of 820), and so on.
Die_1 may store the RTSSM status information for Die_0 during slots 2 and 3, while propagating (without storing) the RTSSM status information belonging to Die_2 and Die_3 during slots 4, 5, 6, and 7.
Die_0 propagates the RTSSM status information for Die_2 and Die_3 during slots 2, 3, 4, and 5, and stores the RTSSM status information for Die_1 during slots 6 and 7.
Each other circuit die may similarly filter the RTSSM status information by only storing RTSSM status information pertaining to the circuit die participating in the same data link.
Upon time slot 8, all circuit dies have stored the RTSSM status information for circuit dies participated in the same data link and may synchronously execute state changes if prompted.

In some embodiments, the slot counter in each tile may be synchronized using specific data patterns on the ring bus during an initialization phase. Such an embodiment may omit the use of the synchronization bit. After the initialization phase is over, the slot used for the RTSSM update, i.e., the end of the ring cycle, may be used to carry these specific data patterns to ensure that all slot counters are still synchronized. It should be noted that other methods of synchronization may be used other than the counter-based methods described above, and such methods and systems should not be considered limiting.

FIG. 10 illustrates a 16-lane retimer in which 16 lanes are distributed across four circuit dies. In the retimer of FIG. 10, horizontal synchronization information is again exchanged directly using the on-chip RTSSM-to-RTSSM (R2R) interface while the vertical synchronization information is exchanged using the ring bus.

In a non-limiting embodiment, a multi-tile PCIe retimer includes four lanes per tile, and up to four tiles. In such an embodiment, data links spanning multiple circuit dies that utilize more than four data lanes are synchronized using the tile-to-tile ring bus. Each lane receives the status information for every other lane. When the RTSSM in each tile analyzes the AND and OR conditions, the current state of the RTSSM is taken into account. After a state change, the condition is updated. Bits on the ring bus may have different meanings depending on the current state of the RTSSM.

In some embodiments, the number of active lanes in a link is configurable. In such embodiments, inactive lanes may insert a ‘1’ into the multi-bit lane status signal for each AND condition and a ‘0’ into the multi-bit lane status signal for each OR condition. In some embodiments, a power of two lanes are active. In such embodiments, if more than four lanes are active, only four or eight lanes may be deactivated. In such a configuration, one or more complete tiles are deactivated.

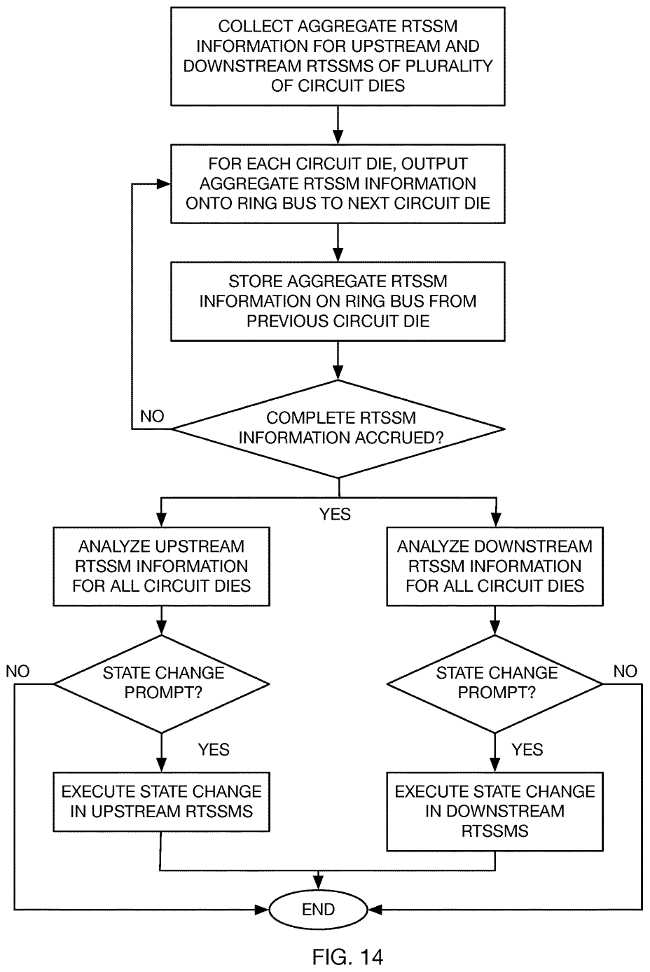

FIG. 14 is a flowchart of a method, in accordance with some embodiments. As shown in FIG. 14, the method includes each collecting, in each circuit die of a plurality of circuit dies, aggregate RTSSM information for upstream and downstream RTSSMs ports on the circuit dies. The method further includes outputting the aggregate RTSSM information onto a ring bus having a connection to the next circuit die in the ring, while also storing the aggregate RTSSM information put onto the ring bus from the preceding circuit die in the ring. If each circuit dies has not fully accrued the complete RTSSM status information from all of the remaining circuit dies, each circuit die repeats the process of outputting the currently held aggregate RTSSM status information onto the ring bus to the next circuit die in the ring while again storing the aggregate RTSSM information put on the ring bus from the preceding circuit die. Once each circuit die has accrued the complete RTSSM status information for all circuit dies, e.g., as indicated by a slot counter, each circuit die analyzes the upstream and downstream RTSSM information. If a state change is prompted for the RTSSMs in either the upstream and/or downstream pseudo-ports, state changes may be synchronously executed in all of the upstream and/or downstream RTSSMs. The plurality of circuit dies may continue to exchange aggregate RTSSM status information for the upstream and downstream pseudo-ports to ensure that the upstream and downstream RTSSMs all remain in the same states.

### Multi-Tile Horizontal Synchronization

When performing horizontal synchronization across multiple tiles, the type of information exchanged is different than the vertical sync information. Exemplary horizontal sync information was described above with respect to Table I. For the full-flexible 8-lane retimer mode of FIG. 11, the two RPCS blocks belonging to a given data lane are located on different circuit dies. In this scenario, the vertical synchronization information is exchanged between the RTSSMs of all links for one direction (i.e., upstream and downstream pseudo-ports) on the same circuit die, while the horizontal synchronization information is exchanged across circuit die boundaries as the upstream and downstream RPCS blocks belonging to the same lane are on different circuit dies.

The RTSSMs in the upstream and downstream pseudo-ports for a given lane do not necessarily need to be in the exact same state. In at least one embodiment, the states of the upstream and downstream RTSSMs is based on respective connections to the root complex and endpoint(s), respectively. For example, in FIG. 11 during startup, the root complex may initiate a link training sequence and the RTSSMs of the upstream pseudo-port on the top circuit die may enter one state, while the RTSSMs in the downstream pseudo-port on the bottom circuit die enter another state based on negotiations with an endpoint. Over the course of the link training sequence the RTSSMs in the upstream pseudo-port progress together while the RTSSMs in the downstream pseudo-port progress together. Furthermore, the upstream and downstream RTSSMs in a given lane exchange lane-specific information with each other. The lane-specific status information may e.g., notify that a device is connected to each pseudo-port, that valid data is being communicated, or that the pseudo-port on one end of the lane is idle.

In multi-tile ‘horizontal synchronization’, the time-slotted ring bus may be utilized in a similar way as the ‘vertical synchronization’. In the 8-lane retimer of FIG. 11, the multi-bit lane status signal may include nine time slots: one time slot per lane, and the ninth slot used for updating RTSSM states. In at least one embodiment using an 8-lane data link, as shown in FIG. 11, the time-slotted ring bus may include 9 time slots: 1 synchronization time slot and 8 lane-specific time slots, i.e., wherein the RTSSM of each data lane outputs its lane-specific ‘RTSSM_hsync’ information. The slot counters may be synchronized as described above, and utilized by the retimer core logic in each lane to know in which time slot to capture the ‘RTSSM_hsync’ information from its corresponding partner in the other circuit die. For example, time slot 0 may correspond to the synchronization cycle, and time slot 1 corresponds to the exchange of information between the upstream and downstream RTSSMs of lane 0. During time slot 1, the downstream RTSSM of port 0 outputs ‘RTSSM_hsync’ information while capturing the ‘RTSSM_hsync’ information put onto the ring bus by the upstream RTSSM of port 0. During time slot 2, the downstream RTSSM of port 1 outputs ‘RTSSM_hsync’ information while capturing the ‘RTSSM_hsync’ information put onto the ring bus by the upstream RTSSM of port 1, etc.

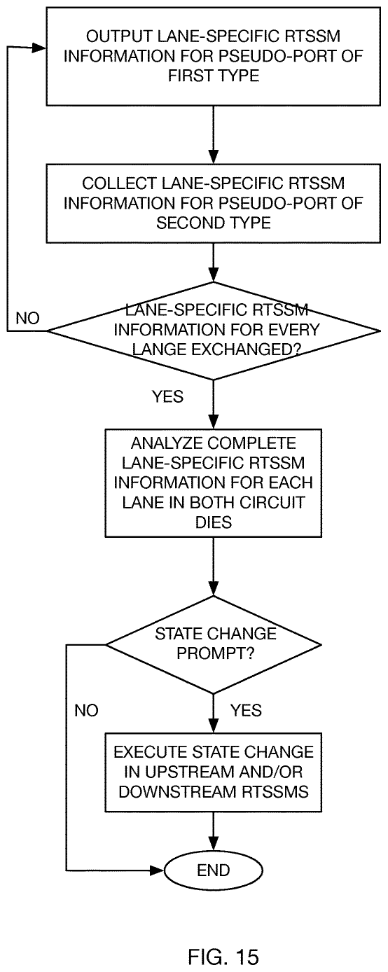

FIG. 15 is a flowchart of a method for horizontal synchronization, in accordance with some embodiments. As described above, the ring bus used for horizontal synchronization corresponds to the same physical connections used for vertical synchronization, and thus operates in a similar manner. Specifically, the method includes outputting the lane-specific RTSSM information for a pseudo-port of one type (upstream/downstream), and collecting lane-specific RTSSM information for the same lane for the pseudo-port of the other type (downstream/upstream). The circuit dies continue to exchange lane-specific RTSSM status information for their own pseudo-port with each other until each circuit die collects the lane-specific RTSSM status information for each lane on the other circuit die. Once the complete lane-specific RTSSM status information for all lanes is exchanged, each circuit die may analyze the lane-specific status information. If expected upstream/downstream conditions are not met for a given lane, then the upstream and/or downstream RTSSMs on each circuit die may synchronously execute state changes.

We claim:

1. An apparatus comprising:
a plurality of circuit dies for retiming serial data links from a root complex to an endpoint;
a plurality of data lanes distributed across the plurality of circuit dies that form a PCIe data link, each data lane comprising a respective upstream and downstream retimer training status and state machines (RTSSMs);
a die-to-die RTSSM sync channel connected between each circuit die configured to carry a multi-bit lane status signal, the multi-bit lane status signal comprising aggregate RTSSM status information for each circuit die that collectively forms complete multi-die RTSSM status information;
a state synchronization pipeline (SSP) in each circuit die, the SSP in a given circuit die configured to receive the multi-bit lane status signal and to accrue the complete RTSSM status information by incrementally storing the aggregate RTSSM status information from the remaining circuit dies, the SSP further configured to output RTSSM status information pertaining to the given circuit die onto the D2D RTSSM sync channel; and
the respective upstream and downstream RTSSMs in each circuit die configured to analyze the aggregate RTSSM status information of the plurality of circuit dies upon synchronous accrual of the complete multi-die RTSSM status information, and to synchronously execute a state change in the circuit die.

2. The apparatus of claim 1, wherein the D2D RTSSM sync channel is a multi-wire parallel bus.

3. The apparatus of claim 1, wherein the aggregate RTSSM status information for each circuit die comprises AND conditions and OR conditions for the upstream and downstream RTSSMs on the circuit die.

4. The apparatus of claim 1, wherein a first circuit die of the plurality of circuit dies comprises upstream RTSSMs and wherein a second circuit die of the plurality of circuit dies comprises downstream RTSSMs.

5. The apparatus of claim 4, wherein the aggregate RTSSM status information for each circuit die corresponds to lane-specific status information.

6. The apparatus of claim 1, wherein each circuit die of the plurality of circuit dies comprises upstream and downstream RTSSMs.

7. The apparatus of claim 6, wherein the aggregate RTSSM status information for each circuit die corresponds to pseudo-port (PP)-specific status information.

8. The apparatus of claim 1, wherein the multi-bit lane status signal comprises a plurality of time slots, each time slot occupied by aggregate RTSSM status information from a corresponding circuit die.

9. The apparatus of claim 8, wherein each circuit die comprises a slot counter configured to maintain a slot count value, the slot count value in each ring counter is initialized based on a synchronization bit circulated during a synchronization time slot and a tile number to maintain synchronous count values between each counter, and wherein accrual of the complete multi-die RTSSM status information occurs at a predetermined slot count value in each counter.

10. The apparatus of claim 9, wherein the multi-bit lane status signal comprises control bits in the time slot occupied by the synchronization bit.

11. A method comprising:
transmitting and receiving serial information using a multi-lane data link distributed across a plurality of circuit dies of a retimer interposed between a root complex and an endpoint, each circuit die comprising respective upstream and downstream groups of retimer training and status machines (RTSSMs);
generating, for each circuit die, local aggregate RTSSM status information including upstream and downstream status information;
outputting the local aggregate RTSSM status information of each circuit die onto a die-to-die (D2D) RTSSM sync channel connected between each circuit die as a multi-bit lane status signal;
incrementally storing, in a respective circuit die, the aggregate RTSSM status information for the remaining circuit dies to accrue complete multi-die RTSSM status information;
responsive to accruing the complete multi-die RTSSM status information, separately analyzing the upstream and downstream status information of the plurality of circuit dies;
executing a synchronous state change between all RTSSMs in each upstream group of RTSSMs based on the analysis of the upstream status information; and
executing a synchronous state change between all RTSSMs in each downstream group of RTSSMs based on the analysis of the downstream status information.

12. The method of claim 11, wherein the D2D RTSSM sync channel is a multi-wire parallel bus.

13. The method of claim 11, wherein the aggregate RTSSM status information for each circuit die comprises AND conditions and OR conditions for the upstream and downstream RTSSMs on the circuit die.

14. The method of claim 11, wherein the local aggregate RTSSM status information output on the D2D RTSSM sync channel comprises inter-pseudo-port (inter-PP) RTSSM status information.

15. The method of claim 11, wherein the local aggregate RTSSM status information output on the D2D RTSSM sync channel comprises intra-pseudo-port (inter-PP) RTSSM status information.

16. The method of claim 11, wherein the multi-bit lane status signal comprises a plurality of time slots, each time slot occupied by aggregate RTSSM status information from a corresponding circuit die.

17. The method of claim 16, wherein the plurality of time slots comprises a synchronization time slot.

18. The method of claim 17, further comprising initializing a slot counter in each circuit die based on a synchronization bit circulated during the synchronization time slot and a tile number to maintain synchronous count values between the slot counter in each circuit die

19. The method of claim 18, wherein accrual of the complete multi-die RTSSM status information occurs at a predetermined slot count value in each counter.

20. The method of claim 17, further comprising outputting control bits in the multi-bit lane status signal during the synchronization time slot.
